(19) United States
(12) Patent Application Publication
(10) Pub. No.: US 2016/0078735 A1
(43) Pub. Date: Mar. 17, 2016

(54) ANTI-THEFT SYSTEM AND ANTI-THEFT METHOD

(71) Applicant: PROEASY NETWORK SOLUTIONS CO., LTD., Hsinchu County (TW)

(72) Inventor: Hsing-Hung Lu, Hsinchu County (TW)

(21) Appl. No.: 14/584,899

(22) Filed: Dec. 29, 2014

(30) Foreign Application Priority Data
Sep. 11, 2014 (TW) 103131331

(51) Int. Cl. G08B 13/24

(52) U.S. Cl. CPC G08B 13/2402

(57) ABSTRACT

An anti-theft system and an anti-theft method are provided. The anti-theft system includes a box, a plurality of identification lines, a first sensor, and a controller. The box includes a host. The identification lines are placed in a default range around the box and constitute a plurality of identification features. The first sensor is configured to capture the identification features. The controller is coupled to the first sensor and configured to determine whether any abnormal identification feature of the captured identification features is found. If any abnormal identification feature of the captured identification features is found, the controller is further configured to send an alert message through a communication module.

### CROSS-REFERENCE TO RELATED APPLICATION

This application claims the priority benefit of Taiwan application serial no. 103131331, filed on Sep. 11, 2014. The entirety of the above-mentioned patent application is hereby incorporated by reference herein and made a part of this specification.

### FIELD OF THE INVENTION

The invention relates to an anti-theft method. More particularly, the invention relates to an anti-theft system and an anti-theft method.

### DESCRIPTION OF RELATED ART

Due to the growing demand for home security, most apartments or buildings are equipped with surveillance cameras to monitor suspicious individuals around the apartments or buildings. However, the hosts of the surveillance cameras or other valuables may accordingly draw attention of thieves.

### SUMMARY OF THE INVENTION

The invention is directed to an anti-theft system and an anti-theft method capable of automatically detecting suspicious individuals around a protected host and thereby issuing an alert message.

In an embodiment of the invention, an anti-theft system that includes a box, a plurality of identification lines, a first sensor, and a controller is provided. The box includes a host therein. The identification lines are placed in a default range around the box and constitute a plurality of identification features. The first sensor is configured to capture the identification features. The controller is coupled to the first sensor and configured to determine whether any abnormal identification feature of the captured identification features is found. If any abnormal identification feature of the captured identification features is found, the controller is further configured to send an alert message through a communication module.

According to an embodiment of the invention, a material of each of the identification lines includes indium tin oxide (ITO).

According to an embodiment of the invention, an operation of the controller determining whether any abnormal identification feature of the captured identification features is found includes: determining whether or not the number of the captured identification features or a shape of the captured identification features is changed; if the number of the captured identification features or the shape of the captured identification features is changed, determining the abnormal identification feature of the captured identification features is found.

According to an embodiment of the invention, the anti-theft system further includes at least one second sensor that is coupled to the controller and arranged on a front surface of the box. The at least one second sensor is configured to detect an approaching object. If one of the at least one second sensor detects the approaching object, the controller is further configured to send the alert message through the communication module.

According to an embodiment of the invention, the communication module supports a wireless communication protocol, and an operation of the controller sending the alert message through the communication module includes: sending the alert message to a mobile communication device through the wireless communication protocol.

In an embodiment of the invention, an anti-theft method for protecting a box is provided. A host is set in the box, and the anti-theft method includes: placing a plurality of identification lines in a default range around the box, wherein the identification lines constitute a plurality of identification features; capturing the identification features by at least one first sensor; determining whether any abnormal identification feature of the captured identification features is found; if any abnormal identification feature of the captured identification features is found, sending an alert message through a communication module.

According to an embodiment of the invention, the step of determining whether any abnormal identification feature of the captured identification features is found includes: determining whether or not the number of the captured identification features or a shape of the captured identification features is changed; if the number of the captured identification features or the shape of the captured identification features is changed, determining the abnormal identification feature of the captured identification features is found.

According to an embodiment of the invention, the anti-theft method further includes: detecting an approaching object by at least one second sensor arranged on a front surface of the box; if one of the at least one second sensor detects the approaching object, sending the alert message through the communication module.

According to an embodiment of the invention, the communication module supports a wireless communication protocol, and the step sending the alert message through the communication module includes: sending the alert message to a mobile communication device through the wireless communication protocol.

Based on the above, the identification lines described herein are placed around the protected host, so as to constitute the identification features which will be continuously monitored. If any suspicious individual appears around the protected host, the suspicious individual may be detected by observing variations in the identification features according to an embodiment of the invention, and an alert message may accordingly be sent.

Several exemplary embodiments accompanied with figures are described in detail below to further describe the invention in details.

### BRIEF DESCRIPTION OF THE DRAWINGS

FIG. 1 and FIG. 2 are schematic views illustrating an anti-theft system according to an embodiment of the invention.

FIG. 3 and FIG. 4 illustrate scenarios of using an anti-theft system according to an embodiment of the invention.

FIG. 5 is a flowchart illustrating an anti-theft method according to an exemplary embodiment of the invention.

### DETAILED DESCRIPTION OF DISCLOSED EMBODIMENTS

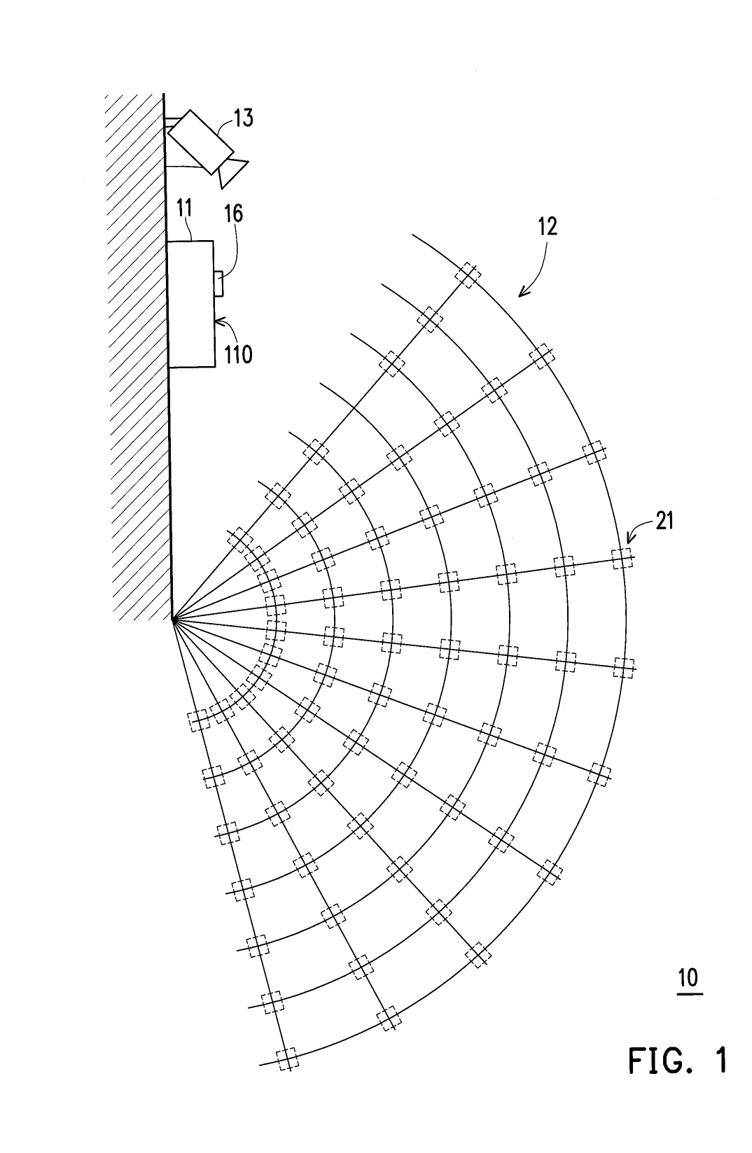

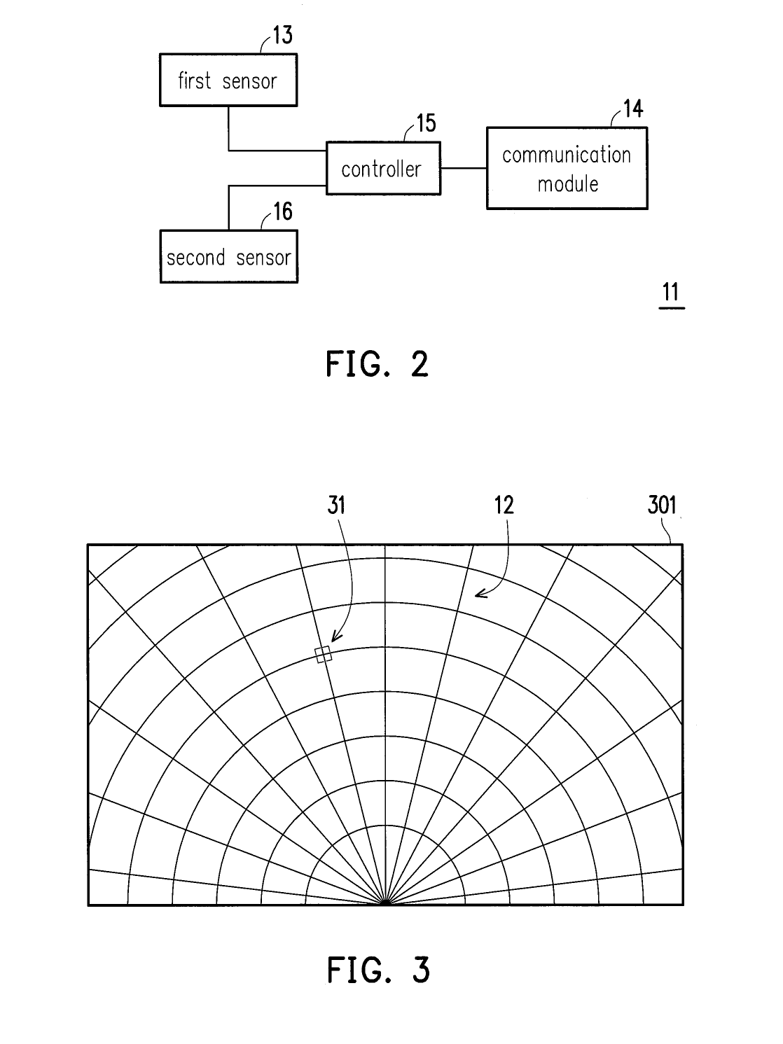

FIG. 1 and FIG. 2 are schematic views illustrating an anti-theft system according to an embodiment of the invention.

With reference to FIG. 1 and FIG. 2, the anti-theft system 10 includes a box 11, a plurality of identification lines 12, a first sensor 13, a communication module 14, and a controller 15.

The box 11 may be made of wood, plastic, metal, and so on, which should not be construed as a limitation to the invention. The box 11 includes one or plural hosts therein. Each host may be a surveillance host, a computer host, or a host of an electronic apparatus, and the invention is not limited thereto. The box 11 is fixed onto a wall or placed in a cabinet, for instance. In principle, the box 11 is arranged in a secure manner, i.e., it is difficult to remove the box 11 or prize the box 11 open.

The identification lines 12 are placed in a default range around the box 11 and constitute a plurality of identification features. The default range may be a circular, semicircular, or rectangular region formed by extending a predetermined distance (e.g., 1-5 meters) in an outward manner from the box 11 as the center. Alternatively, the default range may be of any shape. According to the present embodiment, the identification lines 12 are arranged along at least two directions, and each intersection 21 of the identification lines 12 may be considered as one identification feature. Alternatively, each identification line 12 may be deemed as one identification feature. According to another embodiment, the identification lines 12 may be arranged along at one single direction and may not cross over each other; such that, each identification line 12 may be considered as one identification feature. In another embodiment of the invention, the identification lines 12 may be arranged in any shape, and/or the default range may not be defined by applying the box 11 as the center. These should not be construed as limitations to the invention.

The identification lines 12 are placed on the floor rather than in the air. For instance, the identification lines 12 may be formed by laying certain paint on the floor. In the present embodiment, the identification lines 12 are invisible. For instance, the identification lines 12 may be made of indium tin oxide (ITO) or any other transparent material. Specifically, the identification lines 12 may be made of a transparent paint characterized by high reflectivity. Alternatively, the identification lines 12 may be visible. For instance, the identification lines 12 may be lines in any color. Besides, the identification lines 12 may be wired on the floor or adhered to the floor, which should however not be construed as a limitation to the invention.

The first sensor 13 is placed above the box 11, e.g., on the ceiling or on an upper wall, and the first sensor 13 serves to capture the identification features within the default range (e.g., each intersection 21 in the default range). The number of the first sensor 13 may be one or more. Here, the first sensor 13 may be an infrared camera or another image capturing apparatus and may detect visible or invisible identification features. Besides, the first sensor 13 may be combined with the box 11. For instance, according to an embodiment of the invention, the first sensor 13 may be placed on the front surface 110 of the box 11 and can still capture the identification features.

The communication module 14 may be a wired network interface card and/or a wireless network interface card capable for performing a wired transmission function and/or a wireless transmission function. If the communication module 14 supports wireless transmission, the communication module 14 supports, for instance, a global system for mobile communication (GSM) system, a personal handy-phone system (PHS), a code division multiple access (CDMA) system, a wireless fidelity (WiFi) system, a worldwide interoperability for microwave access (WiMAX) system, a three-generation (3G) wireless communication system, a long term evolution (LTE) system, or a combination thereof; however, the invention is not limited thereto. The communication module 14 described in an embodiment of the invention may also be connected to the internet. According to the present embodiment, the communication module 14 is located within the box 11, while the communication module 14 may be located outside the box 11 or may be independent from the anti-theft system 10 according to another embodiment.

The controller 15 is placed in the box 11 and coupled to the first sensor 13 and the communication module 14. However, in another embodiment of the invention, the controller 15 may be arranged outside the box 11. Here, the controller 15 is, for instance, a central processing unit (CPU), a micro-processor, an embedded controller, or a processing device capable of processing signals. The controller 15 is capable of processing or analyzing images. Based on the images captured by the first sensor 13, the controller 15 determines whether any abnormal identification feature captured by the first sensor 13 is found. For instance, the controller 15 is able to determine whether or not the number of the captured identification features or the shape of the captured identification features is changed. If the number of the captured identification features or the shape of the captured identification features is changed, the controller 15 determines the captured identification features are abnormal. If the number of the captured identification features or the shape of the captured identification features is not changed, the controller 15 determines the captured identification features are normal. If the controller 15 determines the captured identification features are abnormal, it indicates that a suspicious individual may approach the box 11.

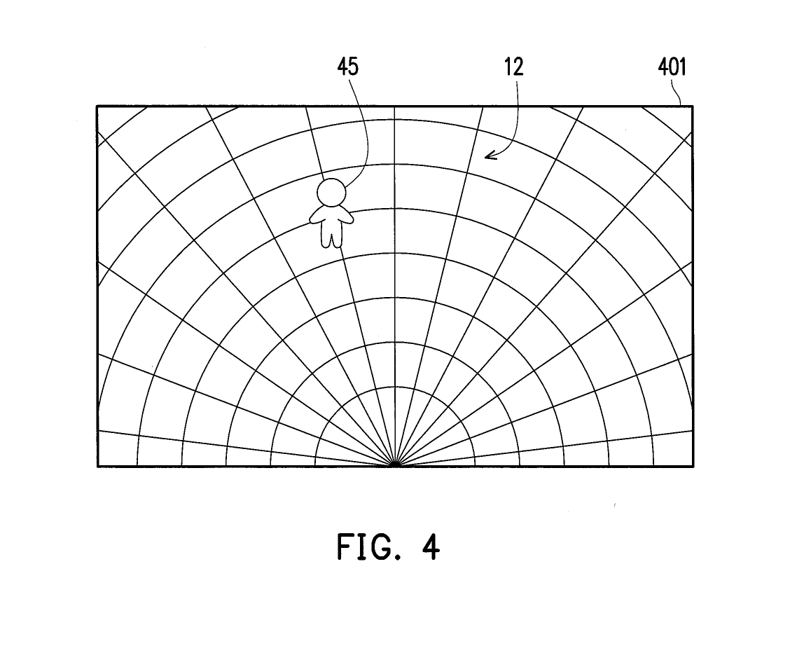

FIG. 3 and FIG. 4 illustrate scenarios of using an anti-theft system according to an embodiment of the invention.

With reference to FIG. 3, under normal circumstances, if no suspicious individual or object approaches the box 11, all of the identification features (e.g., each intersection of the identification lines 12) in the image 301 captured by the first sensor 13 are in the default state. The default state includes the total number of the identification features being a default value and/or the shape of each identification feature being a predetermined shape. If any suspicious individual approaches the box 11 and enters the default range around the box 11, the state of at least some of the identification features in the image captured by the first sensor 13 may be changed. Such change may include the total number of the identification features being smaller than the default value and/or the shape of at least some of the captured identification features not being the predetermined shape.

With reference to FIG. 4, if a suspicious individual 45 enters the default range around the box 11, the intersection 31 and the identification lines around the intersection 31 in the image 401 captured by the first sensor 13 are shielded by the suspicious individual 45. At this time, the number of the identification features in the image 401 is changed (e.g., smaller than the default value), and thus the controller 15 determines the captured identification features in the image 401 are abnormal. Similarly, the controller 15 may also determine the captured identification features in the image 401 are abnormal by detecting changes to the shape of the intersection 31 or the shape of the identification lines around the intersection 31 (e.g., different from the predetermined shape).

If any abnormal identification feature of the captured identification features is found, the controller 15 further sends an alert message through the communication module 14. For instance, the controller 15 may instruct the communication module 14 to send the alert message to relevant parties through internet or according to any wireless communication protocol. The alert message may be sent to a specific mobile communication device or a specific security unit. The specific mobile communication device may belong to an owner or administrator of the box 11 or the host in the box 11, and the security unit is responsible for taking care of or protecting the box 11 or the host in the box 11. After the relevant parties receive the alert message, they may respond properly, e.g., report to the police department or send people to the scene.

As shown in FIG. 2, in another embodiment of the invention, the anti-theft system 10 may further include a second sensor 16. The second sensor 16 may be arranged on a front surface 110 and/or another surface of the box 11. The number of the second sensor 16 may be one or more. The type of the second sensor 16 may be the same as or different from that of the first sensor 13. The second sensor 16 is configured to detect an approaching object. For instance, the second sensor 16 may be an image capturing apparatus, an infrared sensor, a proximity sensor, etc. If at least one second sensor 16 detects the approaching object, the controller 16 may also send the alert message through the communication module 14.

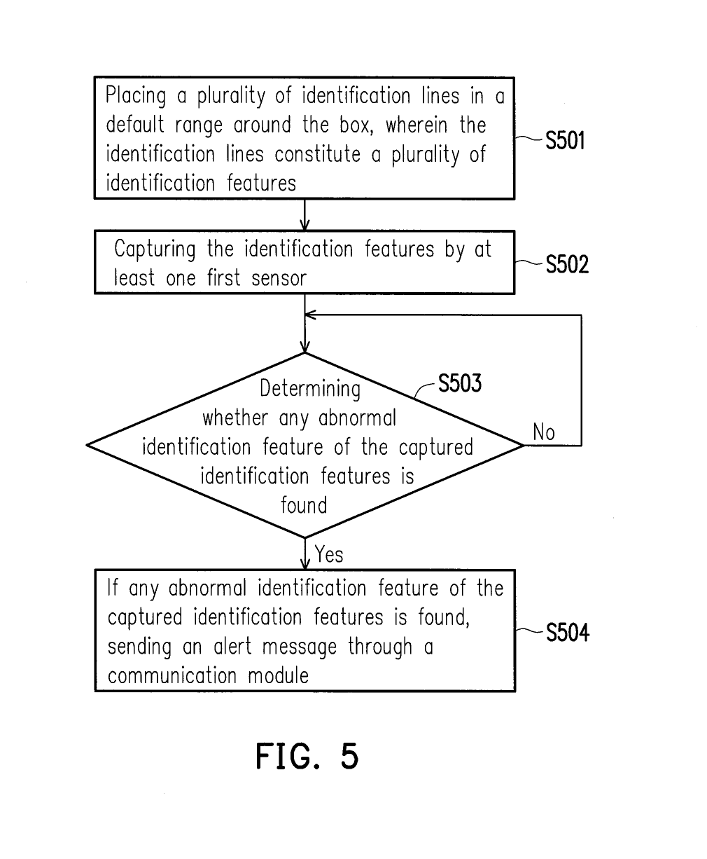

FIG. 5 is a flowchart illustrating an anti-theft method according to an exemplary embodiment of the invention.

With reference to FIG. 5, in step S501, plural identification lines are placed in a default range around a box, and the identification lines constitute a plurality of identification features. In step S502, the identification features are captured by at least one first sensor. In step S503, it is determined whether any abnormal identification feature of the captured identification features is found. If any abnormal identification feature of the captured identification features is found, in step S504, an alert message is sent through a communication module. If no abnormal identification feature of the captured identification features is found, the step S503 is performed again.

Each step shown in FIG. 5 is elaborated above and will not be further explained below. It should be mentioned that each step shown in FIG. 5 may be implemented in form of programming codes or circuits; the invention is not thereby limited. Besides, the method illustrated in FIG. 5 may be applied with or without reference to the previous embodiments, which should however not be construed as a limitation to the invention.

To sum up, in the anti-theft system and the anti-theft method provided herein, the identification lines are placed around the protected host, so as to constitute the identification features which will be continuously monitored. If any suspicious individual appears around the protected host, the suspicious individual may be detected by observing variations in the identification features according to an embodiment of the invention, and an alert message may accordingly be sent to relevant parties.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An anti-theft system comprising:
a box, a host being set in the box;
a plurality of identification lines placed in a default range around the box, the identification lines constituting a plurality of identification features;
at least one first sensor configured to capture the identification features; and
a controller coupled to the at least one first sensor and configured to determine whether any abnormal identification feature of the captured identification features is found,
wherein if any abnormal identification feature of the captured identification features is found, the controller is further configured to send an alert message through a communication module.

2. The anti-theft system as recited in claim 1, wherein a material of each of the identification lines comprises indium tin oxide.

3. The anti-theft system as recited in claim 1, wherein an operation of the controller determining whether any abnormal identification feature of the captured identification features is found comprises:
determining whether or not the number of the captured identification features or a shape of the captured identification features is changed; and
if the number of the captured identification features or the shape of the captured identification features is changed, determining the abnormal identification feature of the captured identification features is found.

4. The anti-theft system as recited in claim 1, further comprising:
at least one second sensor coupled to the controller and arranged on a front surface of the box,
wherein the at least one second sensor is configured to detect an approaching object, and
if one of the at least one second sensor detects the approaching object, the controller is further configured to send the alert message through the communication module.

5. The anti-theft system as recited in claim 1, wherein the communication module supports a wireless communication protocol, and an operation of the controller sending the alert message through the communication module comprises:
sending the alert message to a mobile communication device through the wireless communication protocol.

6. An anti-theft method for protecting a box, a host being set in the box, the anti-theft method comprising:
placing a plurality of identification lines in a default range around the box, the identification lines constituting a plurality of identification features;
capturing the identification features by at least one first sensor; and
determining whether any abnormal identification feature of the captured identification features is found; and
if any abnormal identification feature of the captured identification features is found, sending an alert message through a communication module.

7. The anti-theft method as recited in claim 6, wherein a material of each of the identification lines comprises indium tin oxide.

8. The anti-theft method as recited in claim 6, wherein the step of determining whether any abnormal identification feature of the captured identification features is found comprises:
determining whether or not the number of the captured identification features or a shape of the captured identification features is changed; and
if the number of the captured identification features or the shape of the captured identification features is changed, determining the abnormal identification feature of the captured identification features is found.

9. The anti-theft method as recited in claim 6, further comprising:
detecting an approaching object by at least one second sensor arranged on a front surface of the box; and
if one of the at least one second sensor detects the approaching object, sending the alert message through the communication module.

10. The anti-theft method as recited in claim 6, wherein the communication module supports a wireless communication protocol, and the step sending the alert message through the communication module comprises:
sending the alert message to a mobile communication device through the wireless communication protocol.
